(19) United States
(12) Patent Application Publication
(10) Pub. No.: US 2007/0063388 A1
(43) Pub. Date: Mar. 22, 2007

(54) Method and device for transferring thermoformed articles

(76) Inventors: Giorgio Gatti, Novara (IT); Mauro Pesavento, Novara (IT)

Correspondence Address: NIXON & VANDERHYE, PC, 901 NORTH GLEBE ROAD, 11TH FLOOR, ARLINGTON, VA, 22203, US

(21) Appl. No.: 10/537,049

(22) PCT Filed: Nov. 28, 2003
(86) PCT No.: PCT/IB03/05530

§ 371 Date: Nov. 29, 2005

(30) Foreign Application Priority Data
Dec. 4, 2002 (IT) MI2002A002566

(51) Int. Cl. B29C 51/44

(52) U.S. Cl. 264/335; 425/437

(57) ABSTRACT

There are disclosed a method and a device for transferring thermoformed articles from a station to separate the articles to a subsequent processing station, wherein a conditin of vacuum pressure is produced in proximity to the inlet of a transfer duct and inside the duct.

### FIELD OF THE INVENTION

The present invention relates to a method and a device for transferring articles produced in a thermoforming mould towards a station to stack the articles thereby produced.

### BACKGROUND ART

A method and a device according to the present invention can for example be utilized in thermoforming plants destined to produce hollow articles, such as cups, plates, trays or other such disposable products. These articles are produced from one or more thermoformable materials, such as polystyrene, polypropylene, polyethylene or the like, which are extruded in the form of a continuous sheet. In thermoforming processes, the articles produced with this technology are generally transferred to a subsequent processing station, for example a station to stack the cups.

In some prior art machines, the sheet exiting from the forming unit still carries the thermoformed articles with it to a cutting station, wherein the individual articles are separated from the rest of the sheet and transferred to the stacking station. Transfer of the articles is performed in this case with mechanical means that insert each of the articles into a corresponding guide duct to reach jets of air capable of propelling each article towards a stacking station.

In other prior art machines, for example machines of the type with a tilting half-mould, after separation from the rest of the sheet the thermoformed articles in the mould are ejected mechanically from the mould and deposited directly on stacking channels equipped with stop bosses or holding means, such as brushes, hooks or the like, or deposited directly on suitably shaped elements (also know as “male tools”) on which the articles are temporarily held during transfer.

These known systems have various drawbacks. Firstly, mechanical handling during the various stages of the transfer phases can cause damage to the articles. As well as influencing the quality of the final product, and increased production costs due to rejects, this can jeopardize the correct performance of the subsequent phases, for example correct stacking of the articles produced, and cause halts in production to restore the correct operating conditions of the production cycle.

Moreover, it is evident that the need to move various mechanical members in the various transfer stages can have a noteworthy incidence on the transfer speed of the articles, thus making known systems somewhat unsuitable for use in plants with high productivity levels.

Considering that the majority of articles produced with the thermoforming technology are destined for use with foods, the amount of mechanical handling can also cause noteworthy problems concerning hygiene.

### SUMMARY OF THE INVENTION

The object of the present invention is therefore to provide a method for transferring articles produced in a thermoforming mould wherein mechanical handling of the thermoformed articles can be limited to as great an extent possible.

Another object of the present invention is to provide a method and a device that make transfer of the thermoformed articles extremely rapid.

These objects are obtained by a method according to claim 1 and a device according to claim 15. Further advantageous characteristics of the present invention are indicated in the dependent claims.

According to a first aspect of the present invention, a method is provided to transfer thermoformed articles, separated with respect to a sheet of thermoformable material, from a station for separation of the articles to a subsequent processing station, characterized in that each of the articles exiting from the separation station is picked up by suction and made to travel inside a corresponding duct by a condition of vacuum pressure produced in proximity to the inlet of the duct and inside this duct. In this way, the articles can be transferred in the ducts without any mechanical handling.

The condition of vacuum pressure is preferably produced by injecting pressurized air in an intermediate portion of the duct. Control and implementation of transfer of the articles is thus particularly simple, rapid and reliable.

The pressurized air can be implemented in the form of individual jets, or in the form of a blade of air.

According to a possible embodiment of the method of the present invention, each article is made to travel to the output of the corresponding duct and directed along one or more guide members. This is suitable, for example, for the production of small and medium sized cups, for which transfer to the subsequent processing station, for example a stacking station, can continue successively by gravity.

Alternatively, each article is deposited on a shaped element having form and dimensions essentially complementary to those of the article. The shaped element is movable between at least one position to receive the corresponding article and at least one position to release the article towards the subsequent processing station. This alternative embodiment is suitable to be utilized for large cups, or for plates or trays.

In accordance with a second aspect of the present invention, a device is provided to transfer the thermoformed articles, separated with respect to a sheet of thermoformable material, from a station to separate the thermoformed articles to a subsequent processing station, characterized by including means to produce a condition of vacuum pressure in proximity to the inlet of a transfer duct and inside this duct.

### BRIEF DESCRIPTION OF THE DRAWINGS

Further characteristics and advantages of the present invention shall become clearer from the description hereunder, provided with reference to the accompanying drawings, wherein:

FIG. 1 is a view showing the principle of the method according to the present invention;

FIGS. 2A-2C are views showing some of the transfer phases of an article according to the method of the present invention;

FIG. 3 is a view showing another embodiment of the method according to the present invention;

FIG. 4 is a view showing a further embodiment of the method according to the invention; and

FIG. 5 is a section view showing another possible embodiment of a duct according to the present invention.

### MODES FOR CARRYING OUT THE INVENTION

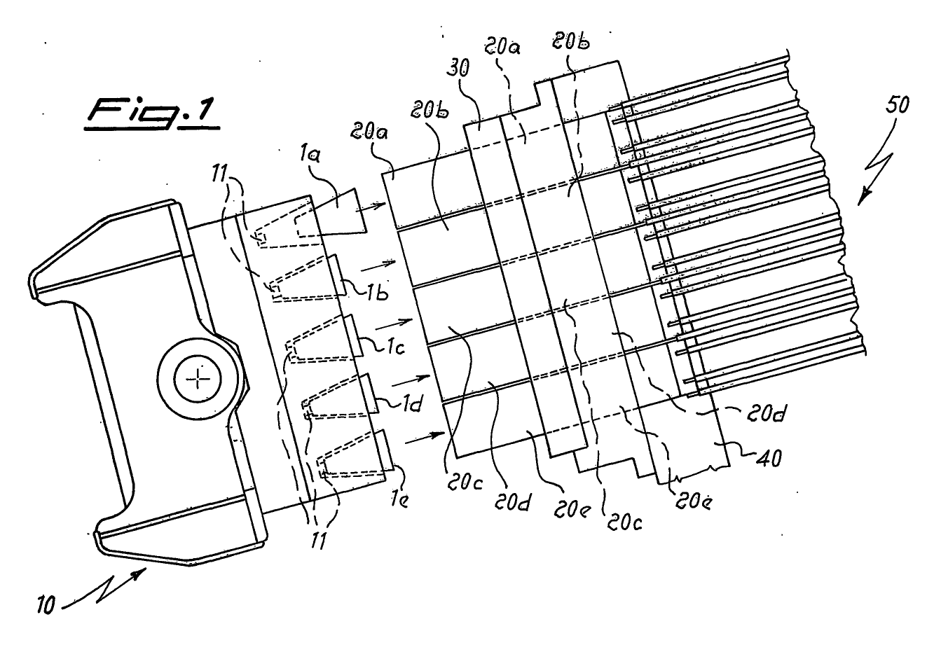

FIG. 1 shows a thermoforming mould 10 for simultaneously producing a plurality of cups 1a-1e during the transfer phase of the thermoformed articles towards a plurality of corresponding cylindrical ducts 20a-20e. The embodiment is shown as an example with reference to a thermoforming system of the type with a tilting mould, wherein the cups are separated from the sheet of thermoformable material in the mould, although the principles of the present invention can in any case also be utilized to transfer articles first formed and then separated in a cutting unit separate from the mould.

It must be mentioned that, although five cavities and five corresponding ducts are visible in FIG. 1, the overall cavities of the mould 10 and the corresponding ducts are organized according to a two-dimensional matrix, wherein several rows (or several columns) are present in addition to the one represented.

The ducts 20a-20e are mounted on a supporting plate 30 through which pressurized air is fed simultaneously to all the ducts 20a-20e at pre-established times, that is in an interval of time during which the mould 10 is in the position wherein the various cavities are aligned with the ducts 20a-20e.

The supporting plate 30 is in turn mounted on a frame 40, connected to which are guide members 50 defining a separate route for each of the articles exiting from the corresponding duct to a subsequent processing station, for example a station to stack the cups.

When the mould 10 moves towards the position shown in FIG. 1, the cups 1a-1e are ejected slightly from the mould 10 with the mechanical means shown schematically and indicated with the reference number 11. In this phase, the cups project slightly from the mould, as shown for the cups indicated with 1b-1e.

At this point, each of the cups is in a position sufficiently close to the inlet of the respective duct and the vacuum pressure produced in this area by the pressurized air fed into the duct allows the cup to be drawn by suction into the duct, as indicated in this case for the single cup 1a in FIG. 1. It must in any case be mentioned that all the cups in the same mould move essentially simultaneously towards the respective ducts and the representation utilized in FIG. 1, with the cup 1a in a position farther forward with respect to the others, is provided purely as an example.

Air is injected at a pre-established pressure and maintained for a time sufficient to guarantee that the cups are ejected from the respective ducts and continue their travel through the guide members 50 to the subsequent processing station.

For example, during testing to perform transfer of cups with average dimensions (i.e. from 15 to 25 cc), the pneumatic circuit was supplied with pressures not exceeding 5 bar and maintained for around 1-2 seconds at each transfer cycle. With these values, it was possible to transfer cups that were fed with their closest edge at a distance not exceeding around 20 mm from the inlet of the corresponding ducts.

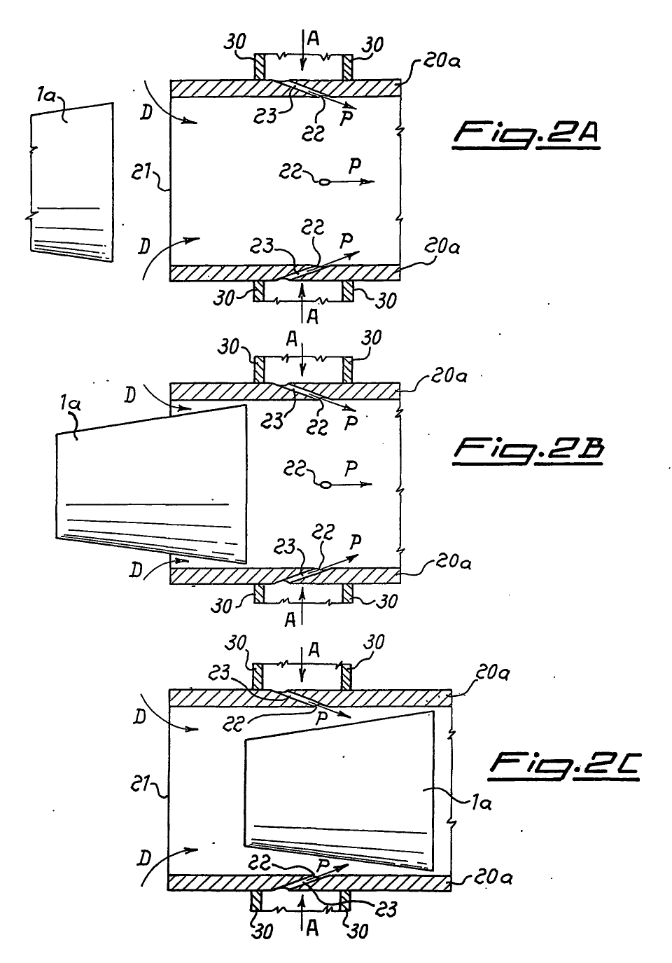

The phases to transfer a single cup (for example the cup 1a through the corresponding duct 20a) are shown in greater detail in the sectional views in FIGS. 2A-2C. The illustrations in these Figures are also valid for the remaining pairs of cups/ducts 1b-1e/20b-20e.

In FIG. 2A the cup 1a is shown in the phase wherein it is subjected to a condition of vacuum pressure, shown by the arrows D, in proximity to the inlet 21 of the duct of circular section 20a. The condition of vacuum pressure in proximity to the inlet 21 is produced by pressurized air (arrows P) injected into an intermediate portion of the duct through a series of nozzles 22.

The nozzles 22 are preferably disposed in equidistant positions from the inlet and equally spaced from one another along the internal surface of the duct 20a. As an example, a single series of nozzles inside the duct 20a are shown, although, if necessary, several series of nozzles can be provided along the duct.

The pressurized air (arrows A) can for example be fed through suitable channels in the supporting plate 30 and directed at the nozzles 22 by inclined through holes 23, so that the jets of pressurized air P are inclined with respect to the axis of the duct.

This injection of air in the intermediate portion of the duct 20a allows a condition of vacuum pressure to be produced not only at the inlet 21 of the duct 20a, but also in the entire duct.

The cup 1a is thus drawn by suction into the respective duct 20a as shown in FIG. 2B. In this position, the cup 1a is still principally subjected to the vacuum pressure D at the inlet of the duct 20a and then continues its travel inside the duct 20a.

Even after the upper edge of the cup 1a has moved beyond the series of nozzles 22 (FIG. 2C), the condition of vacuum pressure D continues along the entire duct 20a and the cup 1a has now reached a speed that allows it to be delivered from the duct, said speed being maintained and/or also increased by any thrust caused by the jets of pressurize air P after the cup has moved beyond the nozzles 22.

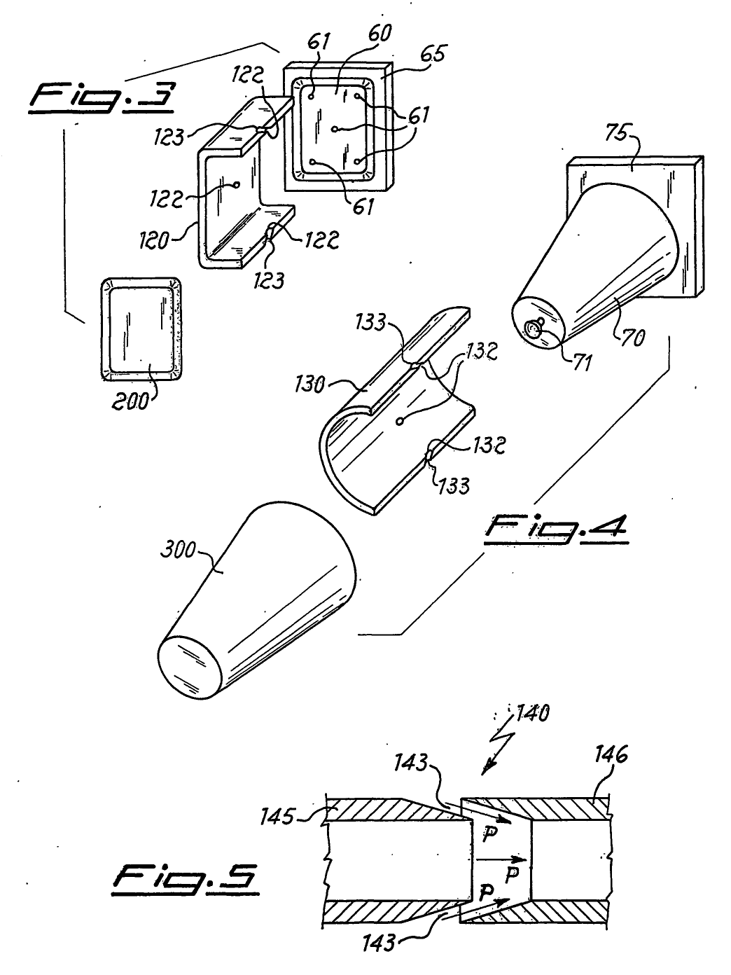

FIGS. 3 and 4 represent alternative embodiments of the invention that are suitable to transfer other types of thermoformed articles.

For the sake of clarity, FIG. 3 represents only half of a duct 120 to transfer a tray 200 with an essentially rectangular form in the plan. The portion represented is obtained by a section along a longitudinal plane passing through the axis of the duct 200, to highlight some inclined is through holes 123 terminating inside the duct 120 in the nozzles 122. The transfer duct has a section with the same form as the form in the plan of the article to be transferred. For example, if the articles produced are circular plates, the duct will also consequently have a circular section.

The operating principle is identical to the one indicated hereinbefore with reference to FIGS. 2A-2C. The tray 200 is drawn by suction into the duct 120 by the vacuum pressure produced at the inlet of the duct by injecting pressurized air through the nozzles 122. Nonetheless, the tray 200 output from the duct 120 is deposited on a shaped element 60, the form and dimensions of which are essentially complementary to those of the tray. The shaped element 60 is mounted for example on a supporting plate 65, together with which it is movable between at least one position to receive the tray (represented in FIG. 3) and a position to release the tray 200 at a subsequent processing station. The plate 65 together with the shaped element 60 can for example be rotatable around an axis parallel to one of its sides, or may be translated and/or rotated with respect to the position indicated.

The tray 200 may be held during movement, ensured for example by vacuum pressure produced between the tray 200 and the shaped element 60 through holes 61.

In FIG. 4 the same principle is utilized to transfer a cup 300 with dimensions relatively larger than those described with reference to FIGS. 1 and 2A-2C. Also in this case, only one half of a cylindrical duct 130 is represented to highlight the inclined holes 133 for injection of the pressurized air through the nozzles 132.

The cup 300 is thus drawn by suction and subsequently deposited on a shaped element 70, having the form of a truncate cone, which for example supports a suction cup 71 to temporarily hold the cup on the element 70. This element is also mounted on a supporting plate 75 which is movable together with the shaped element 70 between a position to receive the cup 300 (represented in FIG. 4) and a position to release it.

Various modifications and improvements may be made without departing from the scope of the present invention.

For example, as shown in FIG. 5, the means to inject pressurized air inside the duct 140 can include at least two portions of contiguous duct 145 and 146, mutually aligned to form at least one continuous peripheral aperture 143 through which a “blade” of continuous air P is injected.

The continuous peripheral aperture 143 has a section inclined with respect to the axis of the duct 140, analogous to the inclined holes described hereinbefore.

In this embodiment it may be advantageous to vary the amplitude of the section of the aperture 143 so that, with the same feed pressure, the speed of the blade of air P injected into the duct can be varied and the conditions of vacuum pressure produced in proximity to and inside the duct can be influenced. This may be implemented in a particularly simple way by providing, for example, suitable means to vary the distance that separates the two contiguous portions of ducts 145 and 146, moving them towards or away from each other.

1. A method for transferring thermoformed articles, which are separated with respect to a sheet of thermoformable material, from a station to separate the articles to a subsequent processing station, characterized in that each of said articles exiting from said separation station is drawn by suction and made to travel inside a corresponding duct as a result of a condition of vacuum pressure produced in proximity to the inlet of said duct and inside said duct.

2. A method according to claim 1, wherein said condition of vacuum pressure is produced by injecting pressurized air into an intermediate portion of said duct.

3. A method according to claim 2, wherein the injection of pressurized air is implemented inside said duct in the form of individual jets delivered from at least one series of nozzles equidistant from said inlet.

4. A method according to claim 1, wherein said nozzles are equidistant from one another along the internal surface of said duct.

5. A method according to claim 1, wherein said nozzles are fed by means of through holes with an axis inclined with respect to the axis of said duct.

6. A method according to claim 2, wherein injection of pressurized air is implemented inside said duct in the form of a blade of air delivered through a continuous peripheral aperture.

7. A method according to claim 6, wherein said continuous peripheral aperture has an inclined section with respect to the axis of said duct.

8. A method according to claim 6, wherein said continuous peripheral aperture has a section of variable width.

9. A method according to claim 1, wherein said article is made to travel to the output of said duct and directed along one or more guide members for each of said articles.

10. A method according to claim 1, wherein said article is made to travel to the output of said duct and deposited on a shaped element, the form and dimensions of which are essentially complementary to those of said article.

11. A method according to claim 10, wherein said shaped element is movable between at least one position to receive said article and at least one position to release said article.

12. A method according to claim 10, wherein said article is held on said shaped element by means of a vacuum pressure produced between said shaped element and said article.

13. A method according to claim 1, wherein said separation station is incorporated in a thermoforming mould.

14. A method according to claim 1, wherein a cutting unit is incorporated in said separation station.

15. A device to transfer thermoformed articles, which are separated with respect to a sheet of thermoformable material, from a station for separating the thermoformed articles to a subsequent processing station, characterized by including means to produce a condition of vacuum pressure in proximity to the inlet of a transfer duct and inside said duct.

16. A device according to claim 15, wherein said means to produce a condition of vacuum pressure consist of means to inject pressurized air into an intermediate portion of said duct.

17. A device according to claim 16, wherein said means to inject pressurized air include at least one series of nozzles disposed inside said duct in positions equidistant from said inlet.

18. A device according to claim 17, wherein said nozzles are equally spaced along the internal surface of said duct.

19. A device according to claim 15, wherein said nozzles form the outlet of through holes with an axis inclined with respect to the axis of said duct.

20. A device according to claim 16, wherein said means to inject pressurized air inside said duct include at least one continuous peripheral aperture.

21. A device according to claim 20, wherein said at least one continuous peripheral aperture has a section inclined with respect to the axis of said duct.

22. A device according to claim 20, wherein said continuous peripheral aperture is positioned between at least two reciprocally aligned contiguous portions of duct.

23. A device according to claim 22, wherein means are provided to move said at least two portions of contiguous duct towards and away from each other to vary the amplitude of the section of said at least one peripheral aperture.

24. A device according to claim 15, wherein said duct is disposed immediately upstream of one or more guide members for each of said articles.

25. A device according to claim 15, wherein it is provided at least one shaped element on which said article is deposited, the form and dimensions of said shaped element being essentially complementary to those of said article.

26. A device according to claim 25, wherein said shaped element is movable between at least one position to receive said article and at least one position to release said article.

27. A device according to claim 25, wherein means are provided to produce a vacuum pressure between said shaped element and said article to hold said article on said shaped element.
